(19) United States
(12) Patent Application Publication
(10) Pub. No.: US 2014/0322422 A1
(43) Pub. Date: Oct. 30, 2014

(54) QUARK MASS HAVING IMPROVED FLAVOUR PROPERTIES

(71) Applicant: DMK Deutsches Milchkontor GmbH, Zeven (DE)

(72) Inventor: Sven-Rainer Döring, Zeven (DE)

(73) Assignee: DMK Deutsches Milchkontor GmbH, Zeven (DE)

(21) Appl. No.: 14/258,670

(22) Filed: Apr. 22, 2014

(30) Foreign Application Priority Data
Apr. 24, 2013 (EP) 13 165 234.9

(51) Int. Cl. A23C 9/142

(52) U.S. Cl. CPC A23C 9/1422
USPC 426/580

(57) ABSTRACT

A quark mass having improved flavour properties is proposed, which can be obtained by
(a) subjecting untreated milk to a heat treatment and separating off the cream,
(b) subjecting the skimmed milk thus obtained to ultrafiltration and/or reverse osmosis and thereby producing a first retentate R1, which contains a dairy-protein concentrate, and a first permeate P1,
(c) subjecting the first permeate P1 to nanofiltration and thereby producing a second retentate R2, which contains alkali salts, and a second permeate P2,
(d) optionally subjecting the second permeate P2 to alkaline demineralisation and thereby producing a third retentate R3, which contains phosphate salts, and a third permeate P3,
(e) the third permeate P3 or respectively the second permeate P2 being combined with the retentate R1 to produce an unacidulated quark mass, and
(f) subjecting the mixture thus obtained to a heat treatment until it is denatured, and finally
(g) adding starter cultures and rennet to the denatured product, and optionally
(h) bringing the quark mass thus obtained to a defined dry mass- and protein content after fermentation is complete.

### FIELD OF THE INVENTION

The invention concerns the field of dairy products and relates to a flavour-improved quark and to a method for the production thereof.

### PRIOR ART

To produce quark, skimmed milk is generally subjected to a heat treatment and the proteins contained therein are denatured.

By subsequently adding lactic-acid bacteria and rennet, what is known as coagulation (phase inversion) of the milk takes place. The casein coagulates and forms what is referred to in technical terms as a gelatinous mass. After maturing (for 8 to 20 hours), the gelatinous mass is stirred, which triggers separation of the whey, and the two phases are then separated in the separator. The liquid acid whey is otherwise processed and the quark mass is brought to the desired fat- and protein content by adding cream.

The technical production methods are made up for the most part of corresponding separating methods. By varying the separation conditions and making technical modifications to the separators, a number of method configurations are currently possible. For skimmed milk having a protein content of 3.3 to 3.5% by weight, the content of skimmed milk is in the range of 4.10 to 4.15 kg skimmed milk per kilogram of low-fat quark or curd cheese to be produced (4.10 to 4.15 kg skimmed milk/kg low-fat quark) if said quark or curd cheese has a dry mass of 18%. Thus, 3.10 to 3.15 kg acid whey per kilogram low-fat quark is produced (3.10 to 3.15 kg acid whey/kg low-fat quark). In this case, the protein content reaches approximately 12.6 to 12.8% by weight.

In addition to the production methods characterised by separation, methods are also known in which the fermented processed milk is concentrated by ultrafiltration. US 2003/0129275 A1 (Lact Innovation), for example, discloses that microfiltration and ultrafiltration steps can be used in cheese- and quark production. The use of microfiltration with skimmed milk for producing cheese and whey protein products is described in US 2003/0077357 A1 (Cornell Research Foundation), for example.

EP1752046 A1 (Tuchenhagen) discloses a method for producing fermented dairy products in which processed milk is fermented, the fermentation product is subjected to microfiltration and only the acidulated retentate is processed further.

However, these prior art methods have two considerable drawbacks:
(i) If skimmed milk is pre-concentrated by ultrafiltration to form a quark mass and then acidulated, the product has a very bitter taste and is not acceptable to the senses, and this is caused in particular by the presence of phosphates. Alkali-metal ions, in particular sodium, tend to produce a metallic taste. The prior art methods of concentrating non-acidulated skimmed milk to form quark have not yet managed to quantitatively separate phosphates and alkali-metal ions, so that amounts remain in the product which are such that an adverse effect on taste cannot be prevented.
(ii) Furthermore, the acid whey is a by-product that is undesirable per se. The separation of the whey from the curd is technically complex and results in a product which only has a small market.

The object of the present invention is thus that of providing a quark mass having improved flavour properties, which, without requiring any additives, is immediately ready to be packaged and consumed. At the same time, the corresponding production method should proceed without the accumulation of acid whey as a by-product.

### DESCRIPTION OF THE INVENTION

A first subject matter of the invention relates to a quark mass having improved flavour properties, which can be obtained by
(a) subjecting untreated milk to a heat treatment and separating off the cream,
(b) subjecting the skimmed milk thus obtained to ultrafiltration and/or reverse osmosis and thereby producing a first retentate R1, which contains a dairy-protein concentrate, and a first permeate P1,
(c) subjecting the first permeate P1 to nanofiltration and thereby producing a second retentate R2, which contains alkali salts, and a second permeate P2,
(d) optionally subjecting the second permeate P2 to alkaline demineralisation and thereby producing a third retentate R3, which contains phosphate salts, and a third permeate P3,
(e) the third permeate P3 or respectively the second permeate P2 being combined with the retentate R1 to produce an unacidulated quark mass, and
(f) subjecting the mixture thus obtained to a heat treatment until it is denatured,
(g) adding starter cultures and rennet to the denatured product, and optionally
(h) bringing the quark mass thus obtained to a defined dry mass- and protein content after fermentation is complete.

A second subject matter of the invention relates to a method for producing a quark mass having improved flavour properties, in which
(a) whey is subjected to a heat treatment and the cream is separated off,
(b) subjecting the skimmed milk thus obtained to ultrafiltration and/or reverse osmosis and thereby producing a first retentate R1, which contains a dairy-protein concentrate, and a first permeate P1,
(c) subjecting the first permeate P1 to nanofiltration and thereby producing a second retentate R2, which contains alkali salts, and a second permeate P2,
(d) optionally subjecting the second permeate P2 to alkaline demineralisation and thereby producing a third retentate R3, which contains phosphate salts, and a third permeate P3,
(e) the third permeate P3 or respectively the second permeate P2 being combined with the retentate R1 to produce an unacidulated quark mass, and
(f) the mixture thus obtained is subjected to a heat treatment until it is denatured, and then
(g) starter cultures and rennet are added to the denatured product, and optionally
(h) the quark mass thus obtained is brought to a defined dry mass- and protein content after fermentation is complete.

Surprisingly, it has been found that a quark having a significantly improved flavour is obtained using the method according to the invention and, at the same time, the undesired accumulation of acid whey, which has to be separated off using a complex process, is prevented. Using the above-described method, the accumulation of acid whey can in particular be reduced by adding only as much permeate as necessary to achieve the required values in the end product when combining the protein fraction and the demineralised milk permeate (for example, quark having a dry mass of at least 18% by weight and at least 12% by absolute weight protein). The remaining volume of milk permeate can be cost-efficiently reused, for example for producing lactose or as an advantageous filler in other products.

### BRIEF DESCRIPTION OF THE DRAWING

The FIGURE is a flow diagram illustrating a conventional method for producing quark (on the left) vs. the method according to the invention (on the right).

### DESCRIPTION OF THE PREFERRED EMBODIMENTS

### Production of the Skimmed Milk

To produce the skimmed milk, solids (“fine particles of curd”) are first separated off and a fat content of approximately 4% by weight is removed from the untreated milk. This usually takes place in a special component, preferably a separator. Components of this type are well known from the prior art. Separators from the company GEA Westfalia Separator GmbH are extremely common in the dairy industry, using which separators the two steps can be carried out individually or jointly.¹ Similar components are also described for example in DE 10036085 C1 (Westfalia) and are very well known to a person skilled in the art, such that carrying out these method steps requires no explanation since it is general knowledge in the art. ¹ (http://www.westfalia-separator.com/de/anwendungen/molkereitechnik/milch-molke.html).

The untreated milk is preferably heat-treated in heat exchangers, special plate heat exchangers having proven to be particularly suitable. There is a temperature gradient in the heat exchangers that is selected such that the untreated milk is heated for a retention time of at least 20 and at most 60 seconds, preferably approximately 30 seconds, to a temperature of approximately 70 to 80° C. and more particularly approximately 72 to 74° C.

### Ultrafiltration and Reverse Osmosis

In the second method step, the skimmed milk is separated by means of ultrafiltration into a dairy-protein concentrate, which accumulates as a retentate, and a milk permeate.

The term “ultrafiltration” means filtration through membranes having a pore size <0.1 μm, while filtration at pore sizes >0.1 μm is usually referred to as microfiltration. Both filtration methods are purely physical, i.e. mechanical, membrane separation methods which operate according to the principle of mechanical size exclusion, namely that of all the particles in the fluids that are larger than the membrane pores are retained by the membrane. The driving force in both separation methods is the differential pressure between the inlet side and the outlet side of the filtering surface, which is between 0.1 and 10 bar. The material forming the filtering surface may consist of stainless steel, plastics material, ceramics or textile fabric, depending on the field of application. There are various forms of filter element, including cartridge filters, flat membranes, spiral-wound membranes, pocket filters and hollow-fibre modules, which are all suitable in principle within the meaning of the present invention.

The ultrafiltration preferably takes place at temperatures in the range of approximately 10 to approximately 55° C., preferably 10 to 20° C., the membrane preferably having a pore diameter in the range of approximately 1,000 to approximately 50,000 Daltons, and preferably approximately 5,000 to approximately 25,000 Daltons. Said membranes are preferably spiral-wound membranes or plate-frame modules made of polysulfone- or polyethylene membranes.

Reverse osmosis is an alternative to ultrafiltration. In this process, the skimmed milk is dehydrated using a semi-permeable membrane, and as a result the concentration of the valuable dairy proteins is increased. The principle consists in the system being subjected to a pressure that is higher than the pressure produced as a result of the osmosis-induced equalisation of concentrations. As a result, the molecules of the solvent can migrate counter to their “natural” osmotic direction of propagation. The process forces said molecules into the compartment in which dissolved substances are less concentrated. Milk has an osmotic pressure of less than 2 bar, and the pressure used for the reverse osmosis of milk is 3 to 30 bar, depending on the membrane and equipment configuration used. The osmotic membrane, which only allows the carrier liquid (solvent) to pass through and retains the dissolved substances (solute), has to be able to withstand these high pressures. If the difference in pressure more than equalises the osmotic gradient, the molecules of solvent pass through the membrane, like in a filter, while the dairy proteins are retained. Unlike a conventional membrane filter, osmosis membranes do not have continuous pores. The reverse osmosis is preferably a reverse osmosis that is carried out at a temperature in the range of 10 to 55° C., preferably 10 to 20° C., using semi-permeable membranes that have a selectivity of 0 to 1,000 Daltons.

### Nanofiltration

The separation of alkali salts, especially sodium- and potassium salts, follows ultrafiltration as the third method step, and is achieved by nanofiltration.

Nanofiltration comes between ultrafiltration and reverse osmosis and is essentially carried out in the same way as ultrafiltration; however, the membranes have even smaller pores and the selectivity is between 100 and 1,000 Daltons (corresponding to an average pore diameter of 0.01 to 0.001 μm), the differential pressure generally being between approximately 3 and 40 bar. Nanofiltration membranes are similar to the membranes used for reverse osmosis. A thin selective layer rests on a support layer. Within the meaning of the method according to the invention, spiral-wound modules are usually used. Owing to the compact construction thereof, it is possible to accommodate large membrane surface areas on small surfaces, and this makes it possible to treat relatively large volume flow rates. In order to use such spiral-wound modules, a feed stream having a low solids concentration is however required.

### Demineralisation

After concentration, if this is required, the permeate from the preliminary stage has a dissolved-phosphate content of approximately 1 to 2% by weight. It is optional, but preferred, for these salts to also be removed after separation of sodium- and potassium salts.

In order to separate the phosphates as completely as possible, the solutions are initially brought to an approximately neutral pH in the range of 6 to 8 by adding bases, and a particular amount of a solution of a water-soluble calcium salt is added to the minerals, which are essentially soluble phosphates, so that poorly soluble calcium salts precipitate. NaOH, an aqueous preparation of calcium chloride, and alkali hydroxide or calcium hydroxide is used for setting the pH and for precipitation. Other alkali- or alkaline earth bases, such as —KOH, can in principle be used for setting the pH. The nature of the precipitated salts is also not critical per se; for example barium salts may precipitate. The use of calcium salts is therefore advantageous in that the precipitating agent is cost-effective and the salts have a very low solubility product, thus resulting in substantially complete precipitation. Even without adding precipitating agents, the demineralisation takes place in a stirred tank, it having proven to be advantageous to set a temperature in the range of approximately 50 to 90° C., and preferably of approximately 80° C. The precipitation time is typically approximately 20 to 120 minutes, and preferably approximately 30 to 45 minutes; however, this information should only be taken as a guide, since lower temperatures need longer reaction times, and vice versa. After precipitation, the salts are separated off, for example in separators, which exploit the relatively high specific weight of the precipitated particles. However, it is equally possible for the separation to be carried out for example through membrane filters within the context of an additional ultrafiltration in the range of 5,000 to 150,000 Daltons, preferably 10,000 to 50,000 Daltons.

### Denaturing

In the following step, the protein-rich fraction from ultrafiltration, that is to say the retentate R1, is combined with the permeate from the demineralisation step, and is subjected to a heat treatment. The denaturing which then takes place can be carried out in a manner known per se, namely for a time period of approximately 5 to approximately 10 minutes, and preferably approximately 6 minutes, and at temperatures of approximately 85 to approximately 90° C., and more particularly approximately 88° C.

### Fermentation and Standardisation

The denatured intermediate product can also be fermented in accordance with the known prior art methods. For this purpose, suitable starter cultures, preferably lactic-acid bacteria, and rennet are added. In particular, probiotic bacteria of the type Bifidobacterium lactis B12 or Lactobacillus acidophilus and mesophilic bacteria such as Lactococcus lactis or Leuconostoc cremoris are suitable as starter cultures.

The temperature at which the fermentation takes place is determined by the optimal temperature range for the micro-organisms used in each case; this temperature is typically in the range of approximately 18 to approximately 35° C., and is preferably approximately 30° C.

The quark mass that is obtained after fermentation is then brought to the desired dry mass- and protein content, for example by adding cream. Preferably, the dry mass content is approximately 15 to approximately 20% by weight, and more particularly approximately 18% by weight. The protein content may be approximately 10 to approximately 15% by weight, and preferably approximately 12% by weight.

### WORKING EXAMPLES

### Comparative Example V1

4 kg skimmed milk was treated at 88° C. for 6 minutes and the proteins contained therein were denatured. Lactic-acid bacteria and rennet were added to the mass, and said mass was matured at 30° C. for approximately 18 hours and was then stirred. The fermentation product was then placed into a centrifuge and approximately 3.2 kg acid whey was separated off as a liquid constituent. The remaining quark mass (approximately 800 g) was brought to a dry mass content of 18% by weight and a protein content of 12% by weight by adding cream.

During tasting, the product was found to be bitter, to have a sandy texture and to be unsuitable for consumption per se.

### Example 1

4 kg skimmed milk was subjected to ultrafiltration at 20° C. using a spiral-wound membrane (selectivity of 25,000 Daltons). The protein-rich retentate was separated off and the permeate was subjected to nanofiltration at 20° C. using a spiral-wound membrane (selectivity 500 Daltons). Sodium- and potassium salts were separated off together with the permeate. The retentate was then treated by adding an aqueous calcium chloride solution which was brought to pH 6 using NaOH and the phosphates precipitated as calcium phosphate. The permeate thus obtained was combined with the protein-rich retentate from the first step, was treated for 6 minutes at 88° C. and the proteins contained therein were denatured. Lactic-acid bacteria and rennet were added to the mass, and said mass was stirred for approximately 2 hours at 30° C. The fermentation product was then placed into a centrifuge and the acid whey was separated off as a liquid constituent. The remaining quark mass was brought to a dry mass content of 18% by weight and a protein content of 12% by weight by adding cream.

During tasting, the product was not found to be bitter and was categorised as being ready to consume.

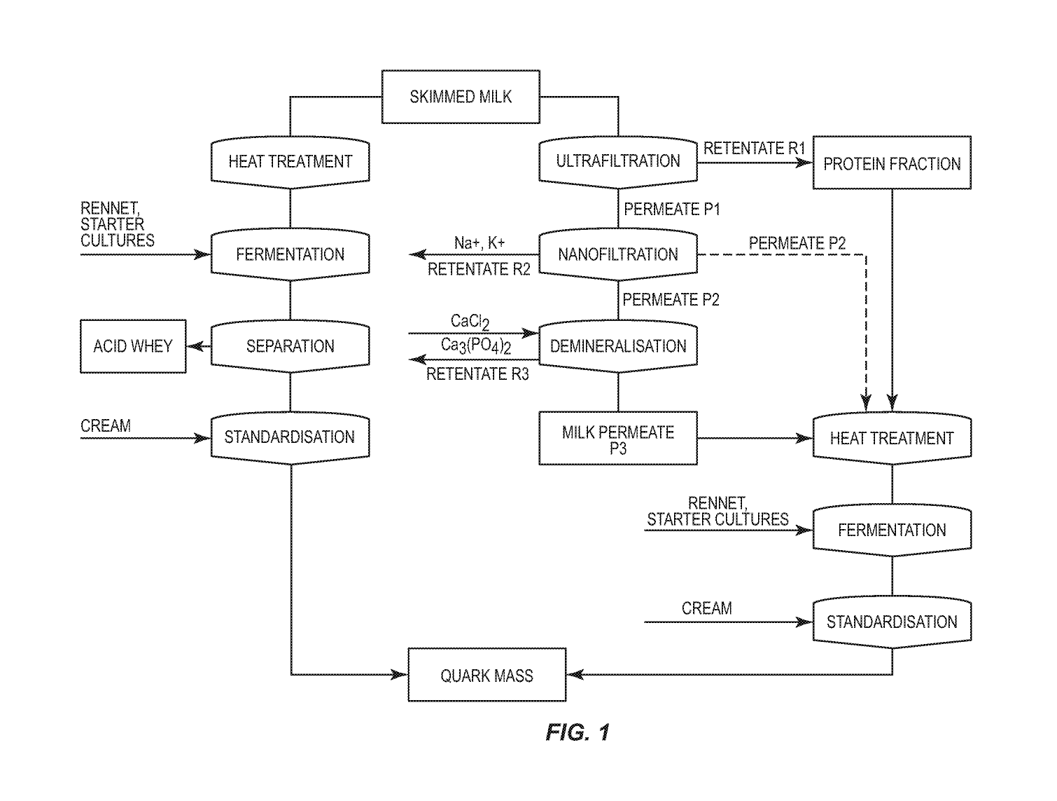

The two methods are reproduced as flow diagrams in FIG. 1.

1. Quark mass having improved flavour properties, which can be obtained by
(a) subjecting untreated milk to a heat treatment and separating off the cream,
(b) subjecting the skimmed milk thus obtained to ultrafiltration and/or reverse osmosis and thereby producing a first retentate R1, which contains a dairy-protein concentrate, and a first permeate P1,
(c) subjecting the first permeate P1 to nanofiltration and thereby producing a second retentate R2, which contains alkali salts, and a second permeate P2,
(d) optionally subjecting the second permeate P2 to alkaline demineralisation and thereby producing a third retentate R3, which contains phosphate salts, and a third permeate P3,
(e) the third permeate P3 or respectively the second permeate P2 being combined with the retentate R1 to produce an unacidulated quark mass, and
(f) subjecting the mixture thus obtained to a heat treatment until it is denatured, and finally
(g) adding starter cultures and rennet to the denatured product, and optionally
(h) bringing the quark mass thus obtained to a defined dry mass- and protein content after fermentation is complete.

2. A method for producing a quark mass having improved flavour properties, in which
(a) untreated milk is subjected to a heat treatment and the cream is separated off,
(b) subjecting the skimmed milk thus obtained to ultrafiltration and/or reverse osmosis and thereby producing a first retentate R1, which contains a dairy-protein concentrate, and a first permeate P1,
(c) subjecting the first permeate P1 to nanofiltration and thereby producing a second retentate R2, which contains alkali salts, and a second permeate P2,
(d) optionally subjecting the second permeate P2 to alkaline demineralisation and thereby producing a third retentate R3, which contains phosphate salts, and a third permeate P3,
(e) the third permeate P3 or respectively the second permeate P2 being combined with the retentate R1 to produce an unacidulated quark mass, and
(f) the mixture thus obtained is subjected to a heat treatment until it is denatured, and finally
(g) starter cultures and rennet are added to the denatured product, and optionally
(h) the quark mass thus obtained is brought to a defined dry mass- and protein content after fermentation is complete.

3. A method according to claim 2, wherein ultrafiltration is carried out using membranes that have a selectivity of 1,000 to 50,000 Daltons.

4. A method according to claim 2, wherein ultrafiltration is carried out using spiral-wound modules or plate-frame modules.

5. A method according to claim 2, wherein ultrafiltration is carried out at a temperature in the range of 10 to 55° C.

6. A method according to claim 2, wherein reverse osmosis is carried out using semi-permeable membranes that have a selectivity of 0 to 1,000 Daltons.

7. A method according to claim 2, wherein reverse osmosis is carried out at a temperature in the range of 10 to 55° C.

8. A method according to claim 2, wherein nanofiltration is carried out using membranes that have a selectivity of 100 to 1,000 Daltons.

9. A method according to claim 2, wherein nanofiltration is carried out using spiral-wound modules.

10. A method according to claim 2, wherein nanofiltration is carried out at a temperature in the range of 10 to 55° C.

11. A method according to claim 2, wherein the purpose of demineralisation, the phosphates are precipitated as calcium salts.

12. A method according to claim 2, wherein demineralisation is carried out at a temperature in the range of 50 to 90° C.

13. A method according to claim 2, wherein the product made up of a combination of the permeate P3 and the retentate R1 is subjected to a heat treatment of 85 to 90° C. for 5 to 10 minutes and is thus denatured.

14. A method according to claim 2, wherein cultures and rennet are added at 25 to 35° C. to the denatured mass thus obtained.

15. A method according to claim 2, wherein the resulting quark mass is brought to a dry mass of 15 to 20% by weight and a protein content of 10 to 15% by weight.
